(19) United States
(12) Patent Application Publication
(10) Pub. No.: US 2014/0361100 A1
(43) Pub. Date: Dec. 11, 2014

(54) Sprinkler system guard

(71) Applicant: Matthew D. Hunsberger, Broken Arrow, OK (US)

(72) Inventor: Matthew D. Hunsberger, Broken Arrow, OK (US)

(21) Appl. No.: 13/986,842

(22) Filed: Jun. 10, 2013

(51) Int. Cl. B05B 15/00

(52) U.S. Cl. CPC B05B 15/001
USPC 239/288.5

(57) ABSTRACT

A sprinkler head protection arrangement is provided having a first plate which is connected to a pipe providing fluid to flow through the plate, a sprinkler head mounted in the first plate to receive and control the fluid flow, and a second plate removably clamped to the first plate with a rigid cage mounted thereon to surround and protect the sprinkler head. The cage is formed from rigid links and rings which resist impact deformation. The second plate is secured to the first plate with minimal fasteners. An impact force absorbing spacer can be mounted between the plates. The sprinkler head can be further separated from impact forces by connecting to the first plate through a sleeve or bushing.

### RELATED APPLICATIONS

This application is a continuation in part of U.S. patent application Ser. No. 13/118,870, filed May 31, 2011, and that prior application claimed the benefit of U.S. Provisional Patent Application No. 61/350,070, filed Jun. 1, 2010.

### FIELD OF INVENTION

The present application relates to sprinkler systems, including those used for fire suppression, and to guards for the sprinkler heads in those systems.

### BACKGROUND AND SUMMARY OF THE INVENTION

This application incorporates by reference all of the content and subject matter of the prior application, Ser. No. 13/118,870, as if fully set forth herein. However, the numbering of elements in the drawings herein is not the same as the numbering of elements in the drawings of the prior application and should not be confused therewith.

In addition, prior sprinkler systems have been used which mount to the sprinkler head itself, and provide a wire cage surrounding the sprinkler head. These cages provide some protection for the sprinkler head against inadvertent “bumps” which could accidentally set off the sprinkler head, but at the same time, they do not significantly impede the flow of water out of the sprinkler head when that is needed. However, these cages, being formed from deformed wire, are more susceptible of additional deformation in the event of collision with another object, such as a basketball in school gym. That additional deformation can, especially with repeated collisions over time, cause the cage to impact the sprinkler head with enough force to set off the sprinkler system. At the same time, providing more rigid and less easily deformed cages can significantly reduce the open area for fluid to flow out of the cage when it is necessary for the sprinkler head to activate. Alternatively, covering more of the area about the sprinkler head to shield it from impact may interfere with the ability of the sprinkler head to detect heat, smoke, or the like, and actuate when it is supposed to. Thus, the sprinkler system would be less effective when it is needed most.

In addition, sprinkler heads occasionally need servicing, repair, and/or maintenance. This typically requires that the cages be removed from the sprinkler heads. Prior cage guards are often more complicated and/or time consuming to remove than would otherwise be desired, particularly when taking into account that many sprinkler heads may need to be serviced at the same time over an entire sprinkler system.

Still too, attaching a guard cage directly to the sprinkler head can cause damage to the sprinkler head upon impact, even if the force is not sufficient to set off the fluid flow. It may, for example, cause the sprinkler head to jam into the pipe or otherwise be more difficult to remove, or have the cage removed from it, for servicing, repair, and/or maintenance.

Accordingly, it is an object of the present invention to provide an improved method and apparatus for protecting sprinkler heads in sprinkler systems, particularly, but not exclusively for fire suppression sprinkler systems. Other objects include the provision of such methods and apparatus which:
a. reduce the cost of manufacturing and use,
b. increase the effectiveness of the sprinkler system,
c. reduce the labor needed for the installation and/or removal,
d. minimize service, repair, and/or maintenance of the sprinkler system,
e. increase the safety and security for persons in the sprinkler system area, and
g. reduce the risk of damage to sprinkler system.

These and other objects of the present invention are obtained by the provision and use of a sprinkler head protection arrangement having a first plate which is connected to a pipe providing fluid to flow through the plate, a sprinkler head mounted in the first plate to receive and control the fluid flow, and a second plate removably clamped to the first plate with a rigid cage mounted thereon to surround and protect the sprinkler head. The cage is formed from rigid links and rings which resist impact deformation. The second plate is secured to the first plate with minimal fasteners. An impact force absorbing spacer can be mounted between the plates. The sprinkler head can be further separated from impact forces by connecting to the first plate through a sleeve or bushing.

Other objects, advantages, and novel features of the present invention will become readily apparent to those of skill in the art from the additional description of the invention below.

### BRIEF DESCRIPTION OF THE DRAWINGS:

FIG. 1 shows an upper front, right perspective view of a preferred embodiment of the present invention.

FIG. 2 shows an exploded view of the embodiment of the present invention shown in FIG. 1, but with the spacer omitted.

FIG. 3 shows an upper front, right perspective view of an alternative embodiment of the present invention.

FIG. 4 shows the same view of the embodiment of FIG. 3 with the cage removed from the sprinkler head, as if for servicing, repair, or maintenance.

### BRIEF DESCRIPTION OF PREFERRED EMBODIMENTS

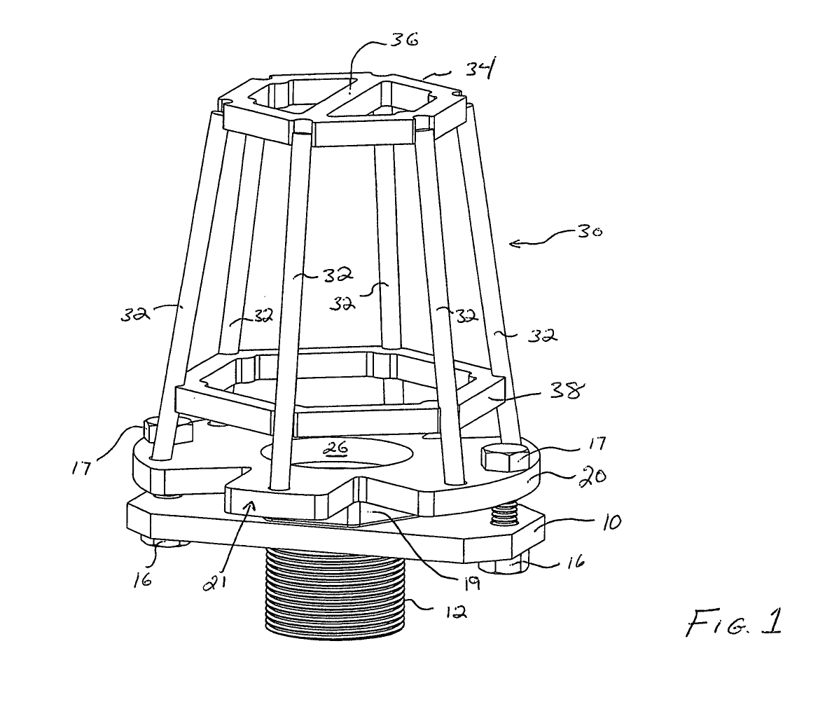

FIG. 1 shows a sprinkler head protection arrangement according to the present invention. This arrangement includes a first or base plate 10 and a second or cover plate 20. Base plate 10 includes a connection member 12 for joining the base plate to a pipe in a sprinkler system. The sprinkler system itself can be any conventional or other system wherein a fluid is provided, for example, through pipes to one or more sprinkler heads which control the distribution of fluid to the environment of use. Connection member 12 may be integrally formed with base plate 10 or may be a separate element which is threaded, welded or otherwise attached to base plate 10. As shown in FIG. 1, connection member 12 is exteriorly threaded to fit into the interior of a pipe of the sprinkler system. Alternatively, connection member 12 could have an internal threading to fit over the exterior of a pipe of the sprinkler system. Alternatively still, connection member 12 could be formed with a ferrule, or press fit, or otherwise be connected to the interior or exterior of a sprinkler system pipe.

Connection member 12 includes a passageway 14 through which fluid from the pipe can pass either directly or through as additional bushing or mounting within passageway 14 in a conventional manner. Passageway 14 is dimensioned so as to receive within it a sprinkler head which controls the distribution of fluid from the pipe of the sprinkler system. The sprinkler head can either be mounted directly to connection member 12, as for example by threading into it, or be mounted indirectly to connection member 12, as for example by threading into a bushing which is itself threaded, press-fit or otherwise attached to connection member 12. That bushing may be of a conventional nature and/or may include some impact absorbing characteristics such that impact forces exerted upon base plate 10 are not fully transmitted to the sprinkler head.

Base plate 10 is connected to cover plate 20, preferably by an easily removable and repeatedly usable fastener arrangement, such as a pair of nuts 16 and bolts 17 on opposite sides of base plate 10. In certain preferred embodiments, cover plate 20 overlaps or extends beyond base plate 10, at least to the extent of lateral flanges 21. As shown, bolts 17 pass through holes 18 on opposite, longitudinal flange portions 11 of base plate 10. Tightening nuts 16 onto bolts 17 will draw base plate 10 and cover plate 20 together. Other fastener elements can be used in place of this pair of nuts and bolts, but the requirements would be that the fasteners securely retain the plates together as needed and be readily removable, preferably with conventional tools or by hand. Also, in certain preferred embodiments, the fasteners would be symmetrically disposed about the plates, such that one plate is not cantilevered off of the other plate. This symmetry is shown in the drawings herein, even as regards to using only a pair of nuts and bolts on opposing flanges.

Spacer 19 can be positioned between base plate 10 and cover plate 20, as desired in particular applications and embodiments. Spacer 19 can be of any conventional material according to the functional characteristics desired. However, if spacer 19 is of a resilient material, it can serve to absorb, at least in part, impact forced applied to the base plate, cover plate, and/or the cage arrangement, and thereby reduce the transmission of impact forces to the sprinkler head and reduce the likelihood of inadvertent actuation of the sprinkler head. In certain preferred embodiments, spacer 19 is circumferentially disposed about passageway 14, but not coextensive with base plate 10, especially with respect to the flange portions of base plate 10. Thus, severe impact forces might be dissipated via a slight rocking or relative motion of the plates with respect to each other, pivoting off of the inter-bolt or trans-bolt axis between bolts 17, but that motion is, by the relative dimensions of the plates (particularly as to lateral overlap) and/or the separation thickness of spacer 19, insufficient to cause a lateral impact on the sprinkler head which would actuate it.

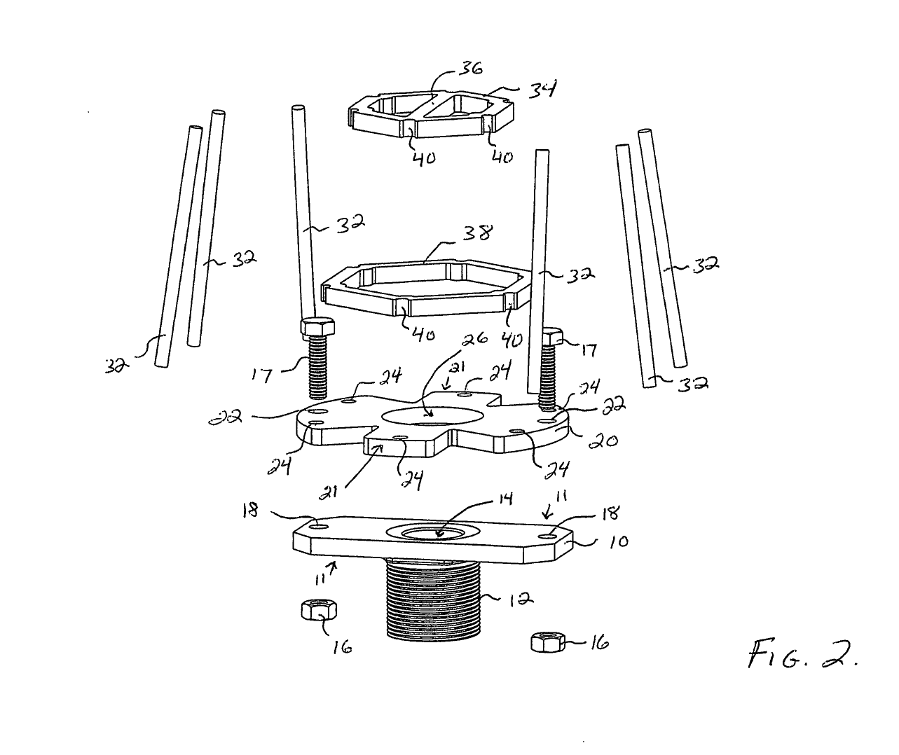

When bolts or like fasteners are used to connect plates 10 and 20, cover plate 20 includes holes 22 aligned with holes 18 to receive therein bolts 17. Cover plate 20 also includes thereon means for mounting a protective cage 30. In the embodiment shown in FIGS. 1 and 2, that mounting means includes holes 24 in cover plate 20. Cover plate 20 also includes passageway 26, through which the sprinkler head may be received.

The protective cage of the present invention is, for example, formed from a plurality of rigid links or bars 32 which are spaced apart circumferentially about the sprinkler head when it is received within passageway 26. These links are, for example, inserted at one end into holes 24 of cover plate 20 and then welded to the cover plate, or, alternatively, are formed with enlargements at one end which prevent them from being pulled completely through cover plate 20. At their ends opposite the attachment to cover plate 20, links 32 are each attached, for example, circumferentially to a top ring 34. That attachment can be by any secure conventional means, such as welding, press fitting, or clamping. Top ring 34 can, for example, be reinforced by top bar 36, extending across its circumference. In the embodiment shown in FIGS. 1 and 2, cage 30 includes a second, lower ring 38. Links 32 are similarly attached about the circumference of ring 38. In other embodiments, lower ring 38 may be omitted. Rings 34 and 38 may, for example, include recesses or notches 40 therein to facilitate placement of bars 32 and manufacture of cage 30.

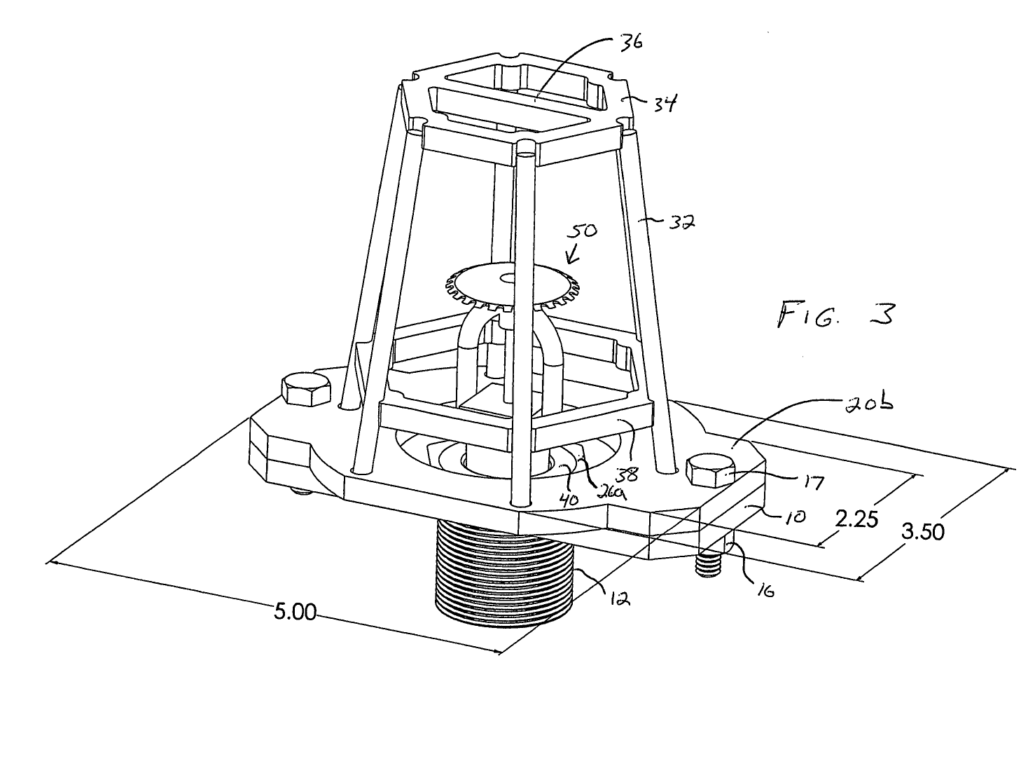

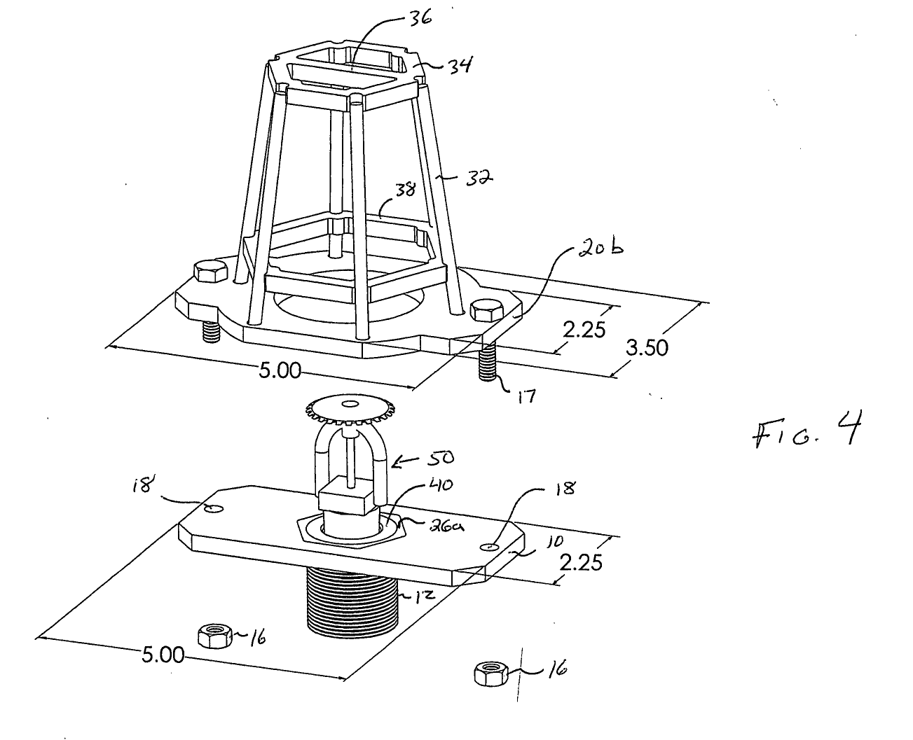

FIGS. 3 and 4 show an alternative embodiment of the present invention which differs primarily in the shape of the cover plate, the absence of a spacer between the plates and the use of a bushing to support the sprinkler head. These figures also illustrate the placement of the sprinkler head within the cage, and the partial disassembly of the arrangement to remove the cage from proximity to the sprinkler head when servicing, repairing, or maintaining the sprinkler head and/or sprinkler system. FIGS. 3 and 4 also provide exemplary dimensional references of the base plates. Where the elements of the embodiment of FIGS. 1 and 2 have not changed in the embodiment of FIGS. 3 and 4, the numbering in the drawings is the same.

FIGS. 3 and 4 show alternative cover plate 20b and alternative passageway 26a through which sprinkler head 50 is received and mounted via bushing 40. Sprinkler head 50 may be of any conventional nature. Bushing 40 is, for example, as described above, and receives sprinkler head 50 therein for direct mounting. Bushing 40 is mounted into passageway 26a.

As shown in FIG. 4, typically only a portion of the sprinkler guard system of the present invention needs to be removed for servicing, repair, and/or maintenance. Further, that removal can be accomplished with only conventional tools and with a minimum of time and effort. Reassembly is similarly facilitated since, for example, the bolt alignment with the holes in the base plate is visually streamlined.

Further, it should be noted that the present invention was designed with aesthetic appeal. The cage arrangement shown in the drawings, for example, is intended to give the visual impression of a more “beefy” or robust and sturdy construction by nature of its angularity and broad plate construction, as compared with prior art constructions.

Each of the components of the present invention can be formed without a deformation process which weakens the element and makes it susceptible to further deformation. Further, the manufacturing process is streamlined since wire bending processes are not needed. Each bar or ring can be stamped or out into the needed shape, which can be more rectilinear and more rigid.

Accordingly, while the present invention has been described above in terms of preferred embodiments, it will be readily understood by those skilled in the art that those are by way of illustration and example only, and not to be taken as a limitation on the invention. The spirit and scope of the present invention are defined instead by the claims following.

What is claimed is:

1. A sprinkler head protection arrangement, for use with a sprinkler system having one or more pipes providing fluid to one or more sprinkler heads for distributing that fluid as needed, comprising:
a base plate, connectable to a pipe of the sprinkler system, and receiving therethrough at least one sprinkler head,
a cover plate, connectable to the base plate, and including means for supporting thereon a cover for the sprinkler head.

2. The arrangement according to claim 1 wherein the base plate includes a threaded portion for engaging the pipe of the sprinkler system.

3. The arrangement according to claim 2 wherein the threaded portion is received within the pipe.

4. The arrangement according to claim 2 wherein the threaded portion receives within it a portion of the pipe.

5. The arrangement according to claim 1 wherein the cover plate includes side portions which substantially overlap the base plate when the cover plate is mounted to the base plate.

6. The arrangement according to claim 1 further including means for connecting the base plate to the cover plate, that connection means being disposed such that the resulting connection does not cantilever the cover plate with respect to the base plate.

7. The arrangement according to claim 6 wherein the connection means provides a repeatedly releasable connection between the base plate and cover plate.

8. The arrangement according to claim 1 further including a spacer mounted between the base plate and the cover plate.

9. The arrangement according to claim 8 wherein the spacer is formed from resilient material.

10. The arrangement according to claim 9 wherein the spacer surrounds the sprinkler head circumferentially.

11. The arrangement according to claim 1 where the cover plate and base plate are connected such that impact forces applied to the protection arrangement may cause relative motion between and among the base plate and cover plate without transmitting those impact forces to the sprinkler head sufficiently to actuate the sprinkler head inadvertantly.

12. The arrangement according to claim 1 wherein the base plate includes a pipe connection means which attaches it to the interior of the pipe.

13. The arrangement according to claim 12 wherein the cover plate is repeatedly releasably connected to the base plate, and the sprinkler system is used for fire suppression.

14. The arrangement according to claim 13 wherein a cage structure is attached to the cover plate as a cover for the sprinkler head.

15. The arrangement according to claim 14 wherein the cage structure is comprised of a plurality of rigid bars which are joined, at least at one end of the bars, to the circumference of a ring.

16. The arrangement according to claim 15 wherein the ring is reinforced by a bar across its circumference.

17. The arrangement according to claim 16 wherein the rigid bars are also joined, intermediate their ends, to the circumference of a second ring.

18. The arrangement according to claim 12, wherein the sprinkler head is mounted within the base plate.

19. The arrangement according to claim 18 wherein the base plate also includes a bushing mounted therein for receiving the sprinkler head.

20. The arrangement according to claim 19 wherein the bushing is formed from material and disposed within the base plate such that it reduces the transmission of impact forces applied to the base plate to the sprinkler head, so as to reduce the likelihood of inadvertent actuation of the sprinkler head.
